(19) United States
(12) Patent Application Publication
(10) Pub. No.: US 2008/0294568 A1
(43) Pub. Date: Nov. 27, 2008

(54) Indexing a financial instrument having optimized constituent weights

(76) Inventor: Jan-Carl Plagge, Frankfurt/Main (DE)

Correspondence Address: NIXON PEABODY, LLP, 401 9TH STREET, NW, SUITE 900, WASHINGTON, DC, 20004-2128, US

(21) Appl. No.: 11/802,929

(22) Filed: May 25, 2007

(51) Int. Cl. G06Q 40/00

(52) U.S. Cl. 705/36 R

(57) ABSTRACT

A computer-implemented method, a computer-readable medium and a data processing apparatus are provided for calculating an index of a financial instrument being weighted with optimized weights. The financial instrument comprises a plurality of constituents. Data reflecting characteristics of the constituents is collected. Based on the collected data, continuous returns are calculated for each of the plurality of constituents. The continuous returns are used for determining a covariance matrix. The weights of all the constituents are optimized by using the covariance matrix. The constituents of the financial instrument are weighted with their respective optimized weights. An index of the financial instrument having its constituents weighted with the optimized weights is determined. The weights of the constituents are kept constant for a predetermined period in time before updated optimized weights are calculated.

### BACKGROUND OF THE INVENTION

1. Field of the Invention

The invention relates to data processing apparatus and methods and, more particularly, to processing data relating to a financial instrument that has a plurality of constituents.

2. Description of the Related Art

Indices which are built from a number of constituents are well known in the art. Generally, in economics and finance, an index (for example a price index or stock market index) is a benchmark of activity, performance or any evolution in general. Well known indices are, for instance, the American Dow Jones Industrial Average and S&P 500 Index, the British FTSE 100, the Japanese Nikkei 225 and the German DAX.

Taking the Dow Jones Industrial Index as an example, in order to calculate the benchmark, the sum of the prices of the 30 stocks used to determine the benchmark is divided by a divisor. The divisor is adjusted in case of splits, spin-offs or similar structural changes, to ensure that such events do not in themselves alter the numerical value of the benchmark. Since the price of each component stock of the Dow Jones Industrial Average is the only consideration when determining the value of the index, the price movement of even a single security will heavily influence the value of the index even though the dollar shift is less significant in a relatively highly valued issue.

In contrast to such a price-weighted index, market value or capitalization weighted indices, such as the German DAX, factor in the size of a company. Therefore, a relatively small shift in the price of a large company will heavily influence the value of the index.

However, the charts of such indices are subject to great variations. Such variations are undesirable since they reduce the predictability of a future chart evolution.

### SUMMARY OF THE INVENTION

In an embodiment, a computer-implemented method is provided for building a financial minimum variance instrument that has a plurality of constituents weighted by respective individual constituent weights. The method comprises accessing data recorded over a predetermined first period of time, the data indicating characteristics of each of the plurality of constituents, determining optimum constituent weights for all of the plurality of constituents by minimizing a financial instrument variance determined from said characteristics of each of the plurality of constituents, and weighting the plurality of constituents by the determined optimum constituent weights.

According to another embodiment, a computer-readable medium is provided that stores instructions that, when executed by a processor, cause the processor to generate a financial instrument having a plurality of constituents weighted by respective individual constituent weights. Data is received which has been recorded over a first predetermined period of time. The data reflects properties of each of the plurality of constituents. Optimum constituent weights for all of the plurality of constituents are determined by maximizing a ratio based on a total return of the financial instrument and a variance of the financial instrument, wherein both the total return and the variance are based on the properties reflected by the data. Each respective individual constituent weight is then associated with its respective determined optimum constituent weight.

In a still further embodiment, there is provided a data processing apparatus for adjusting constituent weights of a financial instrument that has a plurality of constituents. The apparatus comprises a data input unit which is configured to receive information associated with the plurality of constituents and an adjuster. The adjuster is configured to determine a continuous return for each of the plurality of constituents based on the received information, to generate a covariance matrix based at least in part on the determined continuous returns, and to adjust the constituent weights using the covariance matrix.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1a is a block diagram illustrating a data processing apparatus according to an embodiment;

FIG. 1b depicts different charts for illustrating some advantages of the invention according to an embodiment;

FIG. 2 is a timeline illustrating periods of time used according to an embodiment;

FIG. 3 is a block diagram illustrating components of an adjuster comprised in the data processing apparatus according to an embodiment;

FIG. 4 is a block diagram illustrating components of a weight adjuster comprised in the adjuster according to an embodiment;

FIG. 5 is a block diagram illustrating components of an indexer comprised in the data processing apparatus according to an embodiment;

FIG. 6 is a flow chart illustrating a financial instrument building process according to an embodiment; and

FIG. 7 is a flow chart illustrating an optimum weight determination process according to an embodiment.

### DETAILED DESCRIPTION OF THE INVENTION

The illustrative embodiments of the present invention will be described with reference to the figure drawings wherein like elements and structures are indicated by like reference numbers.

Conventional portfolio theory assumes that an investor aims at maximizing the return of a portfolio for a given risk. The risk of a portfolio is determined from the variance of the return. A risk-averse investor tries to keep the risk of an investment as low as possible. Several embodiments of the present invention consider this preference and provide the risk-averse investor with a financial instrument allowing for risk-averse decisions.

Other embodiments of the invention consider, in addition to the minimization of the risk of an investment, the return of it. Thus, these embodiments provide the investor with a trade-off between a risk as low as possible and a return as high as possible.

The present invention may be operational with numerous general purpose or special purpose computing system environments or configurations. Examples of well known computing systems, environments, and/or configurations that may be suitable for use with the invention may include, but are not limited to, personal computers, server computers, hand-held or laptop devices, multiprocessor systems, microprocessor-based systems, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The general purpose or special purpose computing system environments or configurations may be programmable using a high-level computer programming language. In some embodiments, the general purpose or special purpose computing system environments or configurations may also use specially-programmed, special-purpose hardware.

The invention may also be practiced in distributed computing environments where tasks are performed by remote processing devices that are linked through a communication network. In a distributed computing environment, program modules may be located in both local and remote computer storage media including memory storage devices.

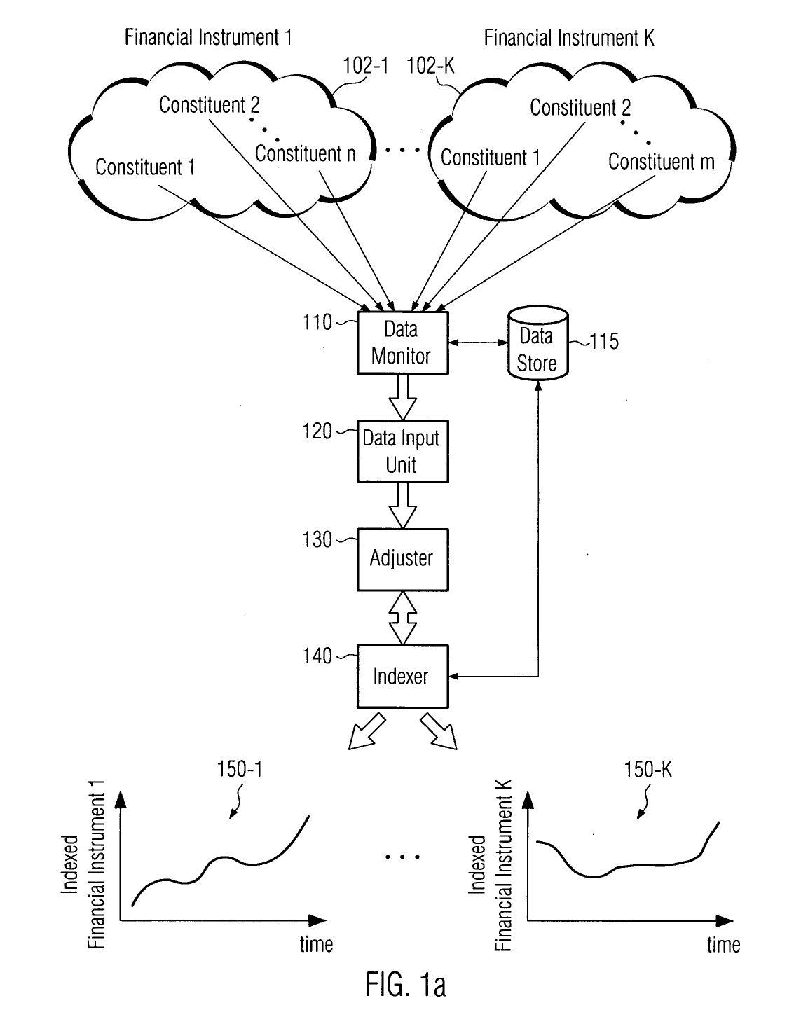

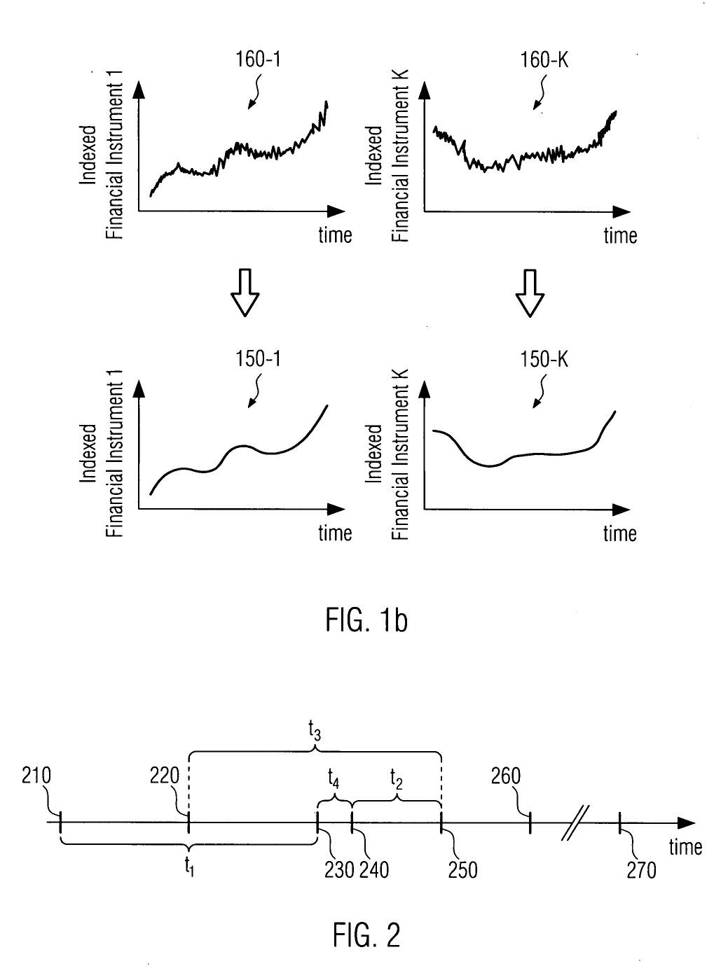

Referring now to FIG. 1a, financial instruments 102-1 and 102-K comprise a plurality of constituents. For instance, financial instrument 102-1 may comprise n and financial instrument 102-K m constituents. Such financial instruments may, for instance, correspond to listings of stocks, such as the stocks building the Dow Jones Industrial Average or the German DAX. The financial instruments 102-1 and 102-K may be used as a tool to represent the characteristics of its component stocks, all of which bear some commonality such as trading on the same stock market exchange or region, belonging to the same industry, or having similar market capitalizations. The financial instruments 102-1 and 102-K may also be associated with indices for derivatives or any other kind of financial instruments.

A data processing apparatus according to an embodiment is illustrated in FIG. 1a. A data monitor 110 may collect data describing characteristics and properties of all the constituents comprised in a financial instrument of interest, for instance, financial instrument 102-1. It will, however, be appreciated that in other embodiments the data monitor 110 may collect data associated with a plurality of financial instruments. In some embodiments, the data monitor 110 may also collect data on the financial instruments 102-1 and 102-K themselves. The collected data may, for instance, reflect price information, interest rates, times of expiration, constituent weights and the like.

The collected data may be stored in a data store 115 for later use or may be directly forwarded to a data input unit 120. In some embodiments, the data input unit 120 may directly access the data store 115 for acquiring the needed information. In other embodiments, the data monitor 110 is solely responsible for providing the input unit 120 with the necessary data by, for instance, accessing the data store 115 for historical data on the constituents of interest and directly forwarding data currently collected. In yet other embodiments, the data input unit 120 may receive data from the data monitor 110 as well as may directly access the data store 115.

The data input unit 120 may forward the data to an adjuster 130. The adjuster 130 may use the data reflecting characteristics of the constituents of a particular financial instrument of interest to adjust the constituent weights of the constituents comprised in the financial instrument of interest and may forward the adjusted constituent weights to an indexer 140.

The indexer 140 may be coupled with the data store 115 and/or the data monitor 110 to be provided with currently collected data on the constituents comprised in the financial instrument of interest. The indexer 140 may use the adjusted constituent weights and the currently collected information on the constituents to calculate an index of the financial instrument of interest, i.e. a statistic reflecting the composite value of the constituents of the considered financial instrument. The calculated index may be output and plotted in a chart 150-1 corresponding to the index of the financial instrument 102-1 or a chart 150-K corresponding to the index of the financial instrument 102-K.

FIG. 1b shows four illustrative charts of indexed financial instruments. Charts 150-1 and 150-K are calculated according to an embodiment of the invention, whereas charts 160-1 and 160-K are calculated using prior art techniques. As an example, let the financial instrument 102-1 of interest be the German DAX. The German DAX is capitalization weighted and comprises the 30 largest German shares. The shares included represent roughly 70 percent of the overall market capitalization of listed German companies. Trading in these shares accounts for more than two thirds of Germany's exchange-traded equity volume. Based on its real-time concept, with updates carried out every 15 seconds, the DAX provides a comprehensive and up-to-date picture of the German stock market as listed on the Prime Standard of the FWB (Frankfurter Wertpapierbörse).

However, the calculation of the DAX index, i.e. the statistic reflecting the composite value of the 30 companies, according to prior art techniques results in a chart, similar to chart 160-1 or chart 160-K, which is subject to great variations making it difficult to predict the future evolution of the index. In contrast to this, charts calculated according to embodiments of the present invention, which may be similar to the illustrative charts 150-1 and 150-K, do not show such variations.

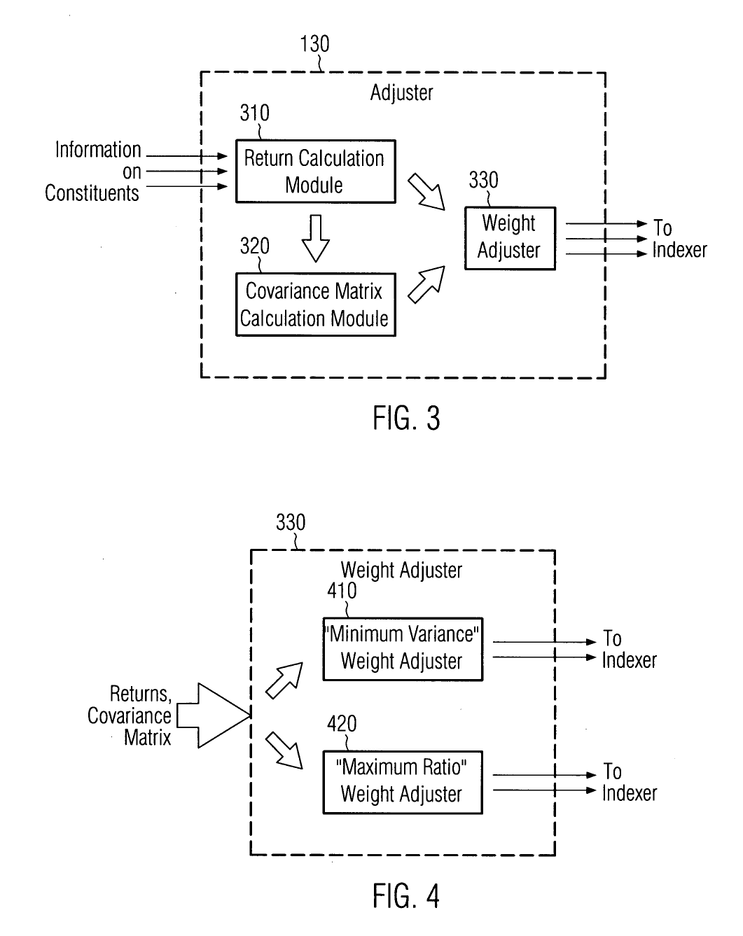

Referring now to FIGS. 2 and 3, the functionality of the data processing apparatus of FIG. 1a according to an embodiment of the present invention is described in more detail. For illustrative purposes only, the financial instrument of interest may be financial instrument 102-1 from FIG. 1a. The financial instrument 102-1 may have n constituents and is monitored by data monitor 110. Additionally, data on the constituents, which has been collected over a first period of time t₁, may be stored in data store 115. The period of time t₁ may be 1 year, 6 months, 3 months or any other suitable time period. The time period t₁ may start at point in time 210 and end at 230. The information on the constituents collected during the period of time t₁ may reflect characteristics or properties of each constituent comprised in financial instrument 102-1 on a daily basis. In some embodiments, however, data for each constituent may have been determined every hour or even every second or any other convenient interval. The data may comprise, as an example and not limitation, the value (for instance price) of each constituent at the point in time where the data is collected, the total number of constituents comprised in the financial instrument 102-1, a floor return level for the financial instrument 102-1 and the like.

A return calculation module 310 included in adjuster 130 may receive information on all constituents of financial instrument 102-1 from the data input module 120. Initially, the data input module 120 may send data reflecting characteristics of each of the plurality of constituents comprised in the financial instrument 102-1 collected during t₁.

The return calculation module 310 may calculate returns of each constituent of financial instrument 102-1, such as continuous returns λ, by using the received information. The continuous return λ of a constituent may be calculated according to the following equation:

$${λ}_{ik} = ln ( \frac{{Constituent}_{k}}{{Constituent}_{k - 1}} ) \qquad Eq . ( 1 )$$

where λᵢₖ is the continuous return of constituent i at point in time k, Constituentₖ is the value (for instance price) of the constituent i collected at the point in time k and Constituentₖ₋₁ is the value of the constituent i collected at the point in time directly preceding k. The return calculation module 310 may calculate returns for as many points in time as needed.

The return calculation module 310 may forward the calculated returns to a covariance matrix calculation module 320 and a weight adjuster 330. Describing first the covariance matrix calculation module 320, the module 320 may calculate a covariance matrix for the constituents of the financial instrument 102-1 based at least in part on the continuous returns calculated by and obtained from the return calculation module 310. Generally, a covariance matrix is a matrix of covariances between elements of a vector. In the present case, each element of the covariance matrix is a covariance between constituents of a financial instrument. The covariance between two constituents is a measure of how much these two constituents vary together (as distinct from variance, which measures how much a single variable varies). If two constituents, for instance, tend to vary together (i.e. when the price of one constituent is above its expected value, then the price of the other constituent tends to be above its expected value too), then the covariance between the two constituents will be positive. The covariance between two constituents i and j of a particular financial instrument may be written as Cov(i,j) or cov_{i,j} and thus the covariance matrix of all n constituents comprised in the financial instrument 102-1 may be read as:

| | | | |
|---|---|---|---|
| Cov (1, 1) | Cov (2, 1) | . . . | Cov (n, 1) |
| Cov (1, 2) | Cov (2, 2) | | Cov (n, 2) |
| . . . | | . . . | |
| Cov (1, n) | Cov (2, n) | . . . | Cov (n, n) |

It is to be noted that the covariance of a value to itself corresponds to the variance of the value.

According to an embodiment of the present invention, the covariance matrix calculation module 320 may determine the covariance matrix based on the continuous returns of all constituents. Thus, the module 320 may determine the covariance between constituents i and j comprised in financial instrument 102-1 according to:

$${cov}_{i , j} = HT \cdot \frac{1}{p - 1} {\sum }_{k = 1}^{p} ( {λ}_{ik} - \overline{{λ}_{i}} ) \cdot ( {λ}_{jk} - \overline{{λ}_{j}} ) \qquad Eq . ( 2 )$$

where cov_{i,j} is the element of the i-th column and the j-th row of the covariance matrix (i.e. the covariance between constituent i and j), p is the total number of points in time for which λᵢₖ and λⱼₖ have been determined, λᵢₖ is a continuous return of constituent i at point in time k, λ̅ᵢ̅ is an average of the continuous returns of constituent i and HT is the number of trading days.

The covariance matrix calculation module 320 may forward the calculated covariance matrix associated with the constituents of financial instrument 102-1 to the weight adjuster 330. The weight adjuster 330 may adjust each respective weight of each constituent based on the received covariance matrix and may send the adjusted weights to the indexer 140.

With reference to FIG. 4, the weight adjuster 330 may comprise a “minimum variance” weight adjuster 410 and a “maximum ratio” weight adjuster 420. In some embodiments, a user may select which adjuster to use. In other embodiments, the weight adjuster 330 may determine “minimum variance” adjusted weights as well as “maximum ratio” adjusted weights and may send both groups of adjusted constituent weights to the indexer 140. In still other embodiments, the weight adjuster 330 may determine which of the two weight adjusters 410 or 420 may be better suited for an investor and may select one of the two weight adjusters 410 or 420 in accordance with the result of such a determination. In some embodiments, such a determination may be based on how risk loving an investor is. In other embodiments, the weight adjuster 330 may evaluate for which of the two adjusters 410 and 420 better data is available.

Describing the “minimum variance” weight adjuster 410 in more detail, the “minimum variance” weight adjuster 410 may determine optimum weights for each constituent of financial instrument 102-1 by minimizing a variance associated with the financial instrument 102-1. The variance may be defined as:

$${σ}_{fl}^{2} = {\sum }_{i = 1}^{n} {\sum }_{j = 1}^{n} {x}_{i} \cdot {x}_{j} \cdot {cov}_{i , j} \qquad Eq . ( 3 )$$

where σ_{fl}² is the variance of the financial instrument of interest having n constituents, xᵢ is the weight of constituent i and cov_{i,j} is the covariance between constituents i and j (i.e. the element of the i-th column and the j-th row of the covariance matrix). The variance of the financial instrument may be rewritten as:

$${σ}_{fi}^{2} = {\sum }_{i = 1}^{n} {\sum }_{j = 1}^{n} {x}_{i} \cdot {x}_{j} \cdot {cov}_{i , j} = {\sum }_{i = 1}^{n} {\sum }_{j = 1}^{n} {x}_{i} \cdot {x}_{j} \cdot {σ}_{i} \cdot {σ}_{j} \cdot {r}_{i , j} \qquad Eq . ( 4 )$$

where σᵢ is the square-root of variance of the constituent i and r_{i,j} is a correlation between constituents i and j. The square-root of variance of constituent i may be written as:

$${σ}_{i} = \sqrt{HT \cdot \frac{1}{p - 1} {\sum }_{k = 1}^{p} {( {λ}_{ik} - \overline{{λ}_{i}} \text{)} )}^{2}} \qquad Eq . ( 5 )$$

where p is the total number of points in time for which λᵢ has been determined, λᵢₖ is a continuous return of constituent i at point in time k, λ̅ᵢ̅ is an average of the continuous returns of constituent i and HT is the number of trading days.

The correlation between constituents i and j may be written as:

$${r}_{i , j} = \frac{{cov}_{i , j}}{{σ}_{i} \cdot {σ}_{j}} = \frac{\frac{1}{p - 1} {\sum }_{k = 1}^{p} ( {λ}_{ik} - \overline{{λ}_{i}} ) \cdot ( {λ}_{jk} - \overline{{λ}_{j}} )}{\sqrt{\begin{matrix}\frac{1}{p - 1} {\sum }_{k = 1}^{p} {( {λ}_{ik} - \overline{{λ}_{i}} )}^{2} \cdot \\ \frac{1}{p - 1} {\sum }_{k = 1}^{p} {( {λ}_{jk} - \overline{{λ}_{j}} )}^{2}\end{matrix}}} . \qquad Eq . ( 6 )$$

where cov_{i,j} is the element of the i-th column and the j-th row of the covariance matrix (i.e. the covariance between constituent i and j), p is the total number of points in time for which λᵢₖ and λⱼₖ have been determined, λᵢₖ is a continuous return of constituent i at point in time k and λ̅ᵢ̅ is an average of the continuous returns of constituent i.

The “minimum variance” weight adjuster 410 may receive the covariance matrix from the covariance matrix calculation module 320 and may minimize the variance σ_{fl}² of financial instrument 102-1 by varying the weights of the constituents. This process may be performed subject to the side conditions:

$$\begin{matrix}{\sum }_{1}^{n} {x}_{i} = 1 and & Eq . ( 7 ) \\ {x}_{i} \geq 0 , where i = 1 , … , n , & Eq . ( 8 )\end{matrix}$$

where n is the total number of constituents comprised in financial instrument 102-1 and xᵢ is the weight of constituent i. The “minimum variance” weight adjuster 410 may use well known optimization techniques for this process, such as, where appropriate, combinatorial methods, derivative-free methods, first order methods and second-order methods. Actual methods falling somewhere among these categories and may also be used, where appropriate, include gradient descent, also known as steepest descent or steepest ascent, Nelder-Mead method also known as the Amoeba method, subgradient method (similar to the gradient method in the case where there are no gradients), simplex method, ellipsoid method, bundle methods, Newton's method, quasi-Newton methods, interior point methods, conjugate gradient method and line search. Other popular methods, which may be used when appropriate, are hill climbing, simulated annealing, quantum annealing, tabu search, beam search, genetic algorithms, ant colony optimization, evolution strategy, stochastic tunneling, differential evolution and particle swarm optimization. The weight adjuster 410 may also use any combination of these methods. The “minimum variance” weight adjuster 410 may determine weights of the constituents for which σ_{fl}² of financial instrument 102-1 is minimum and may forward these weights to indexer 140 as optimum or adjusted constituent weights for financial instrument 102-1.

The “maximum ratio” adjuster 420 may determine optimum weights for each constituent of financial instrument 102-1 by maximizing a ratio, such as a Sharpe ratio, sr_{fi} based on a total return associated with the financial instrument 102-1 and a variance associated with the financial instrument 102-1. The ratio sr_{fi} may be defined by:

$${sr}_{fi} = \frac{{r}_{fi} - {r}_{f}}{{σ}_{fi}} \qquad Eq . ( 9 )$$

where r_{fi} is the total return of the financial instrument, r_{f} is a floor return level and σ_{fi} is the square-root of variance of the financial instrument and may be defined as the square-root of variance from Eq. (3). The floor return level r_{f} may, for instance, be defined by an operator offering the financial instrument as a service tool or may be determined from the returns of the constituents. The total return r_{fi} may be rewritten as:

r_{fi}=π₁·x₁+ . . . +πₙ·xₙ Eq. (10)

where π₁, . . . , πₙ are the returns and x₁, . . . , xₙ the respective weights of the n constituents comprised in the financial instrument 102-1. The returns π₁, . . . , πₙ may be continuous returns and may be defined in accordance with Eq. (1). The returns π₁, . . . , πₙ may be determined in accordance with the period in time t₁, i.e. the return of an individual constituent of the financial instrument may be the natural logarithm of the value (e.g. price) of the individual constituent at point in time 230 (end point of time period t₁) minus the natural logarithm of the value (e.g. price) of the individual constituent at point in time 210 (starting point of time period t₁). Thus, in the case where the period of time t₁ is a 12 month period, the returns π₁, . . . , πₙ reflect the annual returns of the n constituents comprised in the financial instrument.

Hence, the “maximum ratio” weight adjuster 420 may receive the covariance matrix associated with financial instrument 102-1 from the covariance matrix calculation module 320 and returns of all n constituents comprised in the financial instrument 102-1 as well as a floor return level from the return calculation module 310, and may maximize the resulting ratio sr_{fl} associated with financial instrument 102-1 by varying the weights of the constituents. This process may be subject to the side conditions of Eq. (7) and (8). The “maximum ratio” weight adjuster 420 may use well known optimization techniques for this process, such as described in connection with the “minimum variance” weight adjuster 410. The “maximum ratio” weight adjuster 420 thus may determine weights of the constituents for which sr_{fl} of financial instrument 102-1 is maximum and may forward these weights to indexer 140 as optimum or adjusted constituent weights for the constituents of financial instrument 102-1.

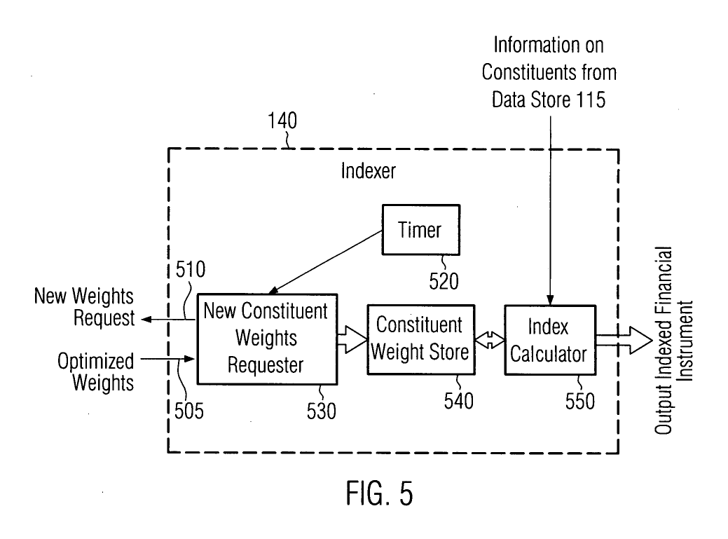

Turning now to FIG. 5, the indexer 140 may comprise, according to an embodiment, a timer 520, a new constituent weights requester 530, a constituent weight store 540 and an index calculator 550. The new constituent weights requester 530 may be responsible for requesting adjusted or optimized constituent weights from the weight adjuster 330. In an embodiment, the requester 530 may also specify the sub-module 410 or 420 from which optimized weights are requested. The requester 530 may receive, in response to a request 510, optimized weights 505 from the weight adjuster 330 and may forward the optimized weights 505 to the constituent weight store 540 which may store the received constituent weights adjusted for the financial instrument 102-1. An index calculator 550 may have access to the constituent weight store 540 and to the data store 115. In some embodiments, the constituent weight store 540 and the data store 115 may forward the needed data to the index calculator 550. The calculator 550 may use the optimized constituent weights 505 stored in constituent weight store 540 and current information on the constituents (e.g. current price) stored in data store 115 and calculate an index of the financial instrument 102-1.

Describing the index calculation process in more detail, while referring to FIG. 2 and FIG. 5, initially, the new constituent weight requester 530 may request adjusted constituent weights determined from characteristics associated with the constituents of the financial instrument 102-1 collected during a first period of time t₁ and may start, at the point in time 240, the calculation of an index of the financial instrument by using the optimized constituent weights. The time period t₄, which indicates the time elapsed between the end of the initial first time period t₁ and the beginning of the first indexing period t₂ (point in time 240), may be as long as one month, one day, one second or any other suitable time period. It is to be noted that during this initial indexing period t₂, no new optimized constituent weights are requested by the requester 530, i.e. the index calculator may use, for the duration of t₂, the optimized weights for the constituents of the financial instrument 102-1 determined from data collected during t₁. Thus, the weights for the indexing process are kept constant for the first indexing period t₂. The period in time t₂ may be 1 week, 1 month, 3 months, 6 months or any other suitable time period.

When t₂ expires (at point in time 250), the timer 520 may prompt the new constituent weight requester 530 to issue a request 510 to the weight adjuster 330 for updated adjusted and optimized constituent weights for the constituents of financial instrument 102-1. In some embodiments, the new constituent weight requester 530 may also specify in its request 510 a third period of time t₃. The third period of time t₃ may indicate to the weight adjuster 330 which data is to be used for the calculation of the updated adjusted weights, i.e. the weight adjuster 330 uses data collected during t₃ for its weight determination process. In an embodiment, the duration of the third period of time t₃ is predetermined and may equal t₁, wherein the starting point 220 of the third period in time t₃ may be after point in time 210 (the starting point of t₁) and may be shifted by t₂ from 210. After having calculated new adjusted constituent weights as described above, the weight adjuster 330 may send these weights as updated optimized constituent weights to the new constituent weight requester 530 which may forward the updated optimized constituent weights to the constituent weight store 540. The constituent weight store 540 may save the updated optimum constituent weights as current constituent weights. In some embodiments, the constituent weight store 540 may overwrite the existing constituent weights, in other embodiments, the constituent weight store 540 may retain the old weights and may mark the updated constituent weights as current weights. The index calculator 550 may access the weight store 540 and may in this way be provided with the updated optimum weights. By using the updated optimum weights, the index calculator 550 may determine the index of the financial instrument 102-1 for a further indexing period, which may have the same duration as the first indexing period t₂ or may have a different duration (starting with point in time 250 and ending with point in time 260). The further indexing period may follow directly the first indexing period t₂ (as indicated in FIG. 2) or may start after a certain time period has elapsed (similar to t₄ and starting at point in time 250).

After the further indexing period has elapsed (at point in time 260), the timer 520 may prompt the new constituent weights requester 530 to issue a request 510 to the weight adjuster 330 for updated optimized constituent weights. The weight adjuster 330 may determine updated optimized weights for the constituents by using data collected during a time period shifted by the duration of the further indexing period from the starting point 220 of the third time period t₃ in accordance with the above described and may send the newly updated optimized constituent weights to the requester 530 which may forward once again the newly obtained optimized constituent weights to the constituent weight store 540. The index calculator 550 may access the weight store 540 and calculate an index of the financial instrument 102-1 using the newly updated optimized weights.

After another indexing period has elapsed (e.g. at point in time 270), the timer 520 may prompt the new constituent weights requester 530 to issue a further request to the weight adjuster 330 for newly updated optimized constituent weights and the above described process may start once again. In some embodiments, the timer 520 may prompt the new constituent weight requester 530 periodically to issue the request 510 for updated optimized constituent weights.

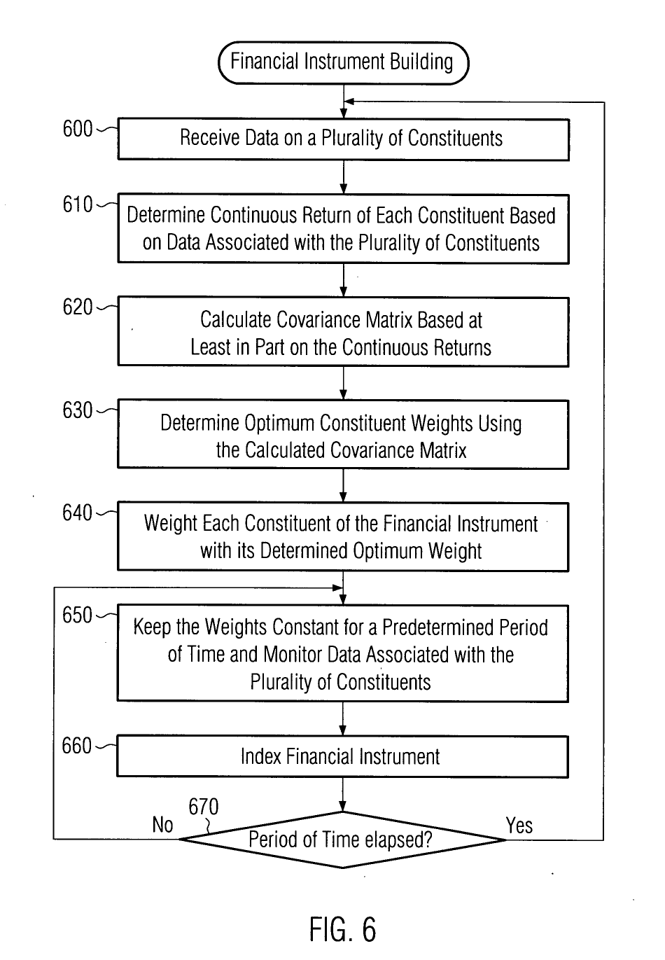

Referring now to FIG. 6, a flow chart is presented showing process steps which may be performed for building a financial instrument such as financial instrument 102-1 or 102-K. At step 600, data on a plurality of constituents comprised in a financial instrument may be received, for instance, by the adjuster 130 from the data input unit 120. Then, at step 610, continuous returns of each constituent may be determined (e.g. by adjuster 130) based on information (e.g. prices) associated with the plurality of constituents in accordance with Eq. (1). The information associated with the plurality of constituents may have been collected (e.g. by data monitor 110) during a first period of time, such as time period t₁, preceding the determination step 610. Further, a covariance matrix may be calculated at step 620. This covariance matrix may be calculated according to Eq. (2) and may thus be based at least in part on the continuous returns determined at step 610.

At step 630, the calculated covariance matrix may be used to determine optimized constituent weights for the financial instrument of interest.

At step 640, each of the plurality of constituents of the financial instrument of interest may be weighted (e.g. by the indexer 140) with its respective, at step 630 determined, optimum weight.

At step 650, the weights of the constituents may be kept constant (e.g. by the indexer 140) for a predetermined second period of time, such as t₂, and data for each of the constituents of the financial instrument of interest may be continuously collected (e.g. by the data monitor 110).

At step 660, an index of the financial instrument may be calculated by using the constantly kept constituent weights and current information on the constituents (e.g. monitored by data monitor 110 and stored in data store 115).

At step 670, a determination may be made whether the second period of time has elapsed. If the second period of time has not elapsed, the index is continuously calculated using the constantly kept constituent weights and current information on the constituents. If the second period of time has elapsed, the process returns to step 600. Hence, the process is performed continuously in this embodiment.

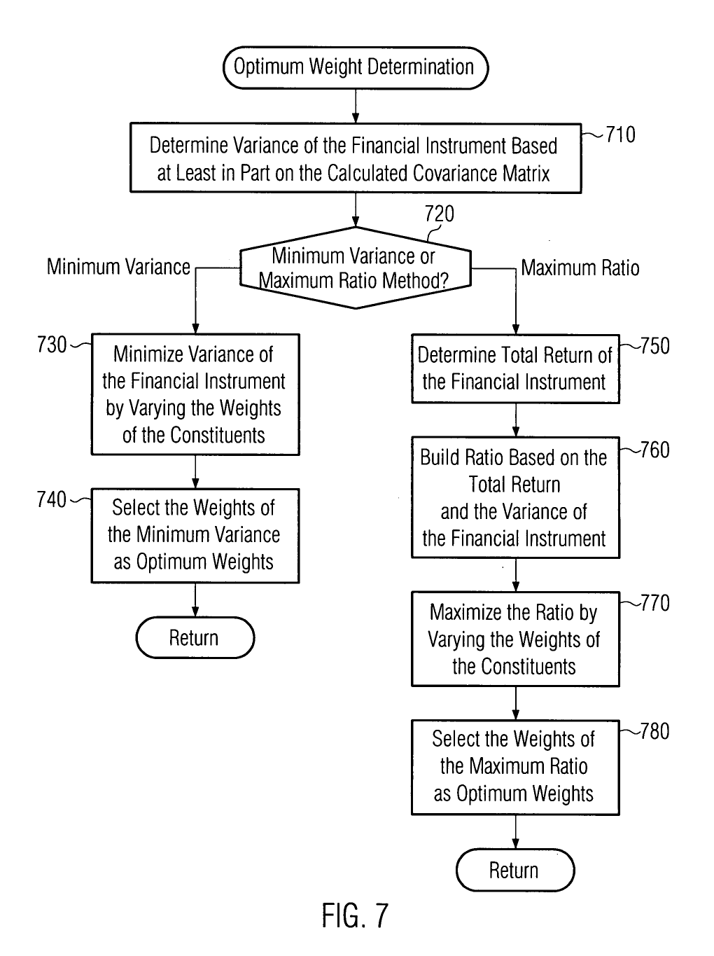

With reference to FIG. 7, a flow chart is presented showing process steps which may be performed for determining optimum constituent weights. This process steps may, for instance, be performed by the components of the adjuster 130.

At step 710, a variance of the financial instrument of interest is determined based on a calculated covariance matrix. The covariance matrix may be calculated according to Eq. (2) and the variance of the financial instrument may be determined according to Eq. (4).

At step 720, a determination may be made whether to determine optimum constituent weights based on minimizing the variance of the financial instrument or based on maximizing a ratio based on a total return associated with the financial instrument and a square-root variance of the financial instrument.

If it is determined at step 720 that the optimum weights are to be determined by minimizing a variance of the financial instrument, the method proceeds to step 730. At step 730, a variance, such as a variance as defined in Eq. (4), may be minimized by varying the weights of the constituents subject to the side conditions as defined in Eq. (7) and (8). The minimization may be performed by using well known optimization techniques as described in conjunction with the “minimum variance” weight adjuster 410.

At step 740, the weights of the variance having the minimum value of all variances may be selected as optimum constituent weights.

If it is, however, determined at step 720 that the optimum weights are to be determined by maximizing a ratio based on a total return associated with the financial instrument and a square-root variance of the financial instrument, the method of FIG. 7 may proceed to step 750. At step 750, a total return associated with the financial instrument, such as defined by Eq. (10), may be determined.

At step 760, a difference between the total return associated with the financial instrument and a floor return level may be identified. Then, a ratio of the difference and the square-root variance of the financial instrument of interest may be built, such as ratio sr_{fi} as defined by Eq. (9).

At step 770, the ratio may be maximized by varying the weights of the constituents associated with the financial instrument of interest. This maximization may be subject to the side conditions as defined by Eq. (7) and (8). The maximization may be performed by using well known optimization techniques as described, for instance, in conjunction with the “minimum variance” weight adjuster 410.

At step 780, the weights of the ratio having the maximum value may be selected as optimum constituent weights.

Hence, the illustrative process of FIG. 6 and the exemplary data processing apparatus of FIG. 1a may provide a risk averse investor with an index of a financial instrument having optimized constituent weights. In some embodiments, the optimization of the constituent weights may be performed by minimizing a variance (risk) associated with the financial instrument. In other embodiments, the optimization may account additionally for a total return of the financial instrument.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. For instance, while at least some of the above embodiments may use historic data such as historical volatilities and/or correlations, it is to be noted that implied volatilities and correlations may be used instead. As commonly used in the art, the term “implied volatility” may refer to the volatility implied by the market price of a derivative security, or the like, based on a theoretical pricing model. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A computer-implemented method of building a financial minimum variance instrument having a plurality of constituents weighted by respective individual constituent weights, comprising:
accessing data recorded over a predetermined first period of time, the data indicating characteristics of each of the plurality of constituents;
determining optimum constituent weights for all of the plurality of constituents by minimizing a financial instrument variance determined from said characteristics of each of the plurality of constituents; and
weighting the plurality of constituents by the determined optimum constituent weights.

2. The computer-implemented method of claim 1, further comprising:
keeping the weights of each of the plurality of constituents constant;
monitoring data indicating characteristics of each of the plurality of constituents while keeping said weights constant; and
recording said monitored data.

3. The computer-implemented method of claim 2, further comprising:
determining, after a second period of time has elapsed, updated optimum constituent weights for all of the plurality of constituents by minimizing a further financial instrument variance determined from characteristics recorded during a third period of time; and
weighting the plurality of constituents by the updated optimum constituent weights.

4. The computer-implemented method of claim 3, wherein the duration of the third period of time equals the duration of the first period of time and wherein the third period of time ends before the updated optimum constituent weights are determined.

5. The computer-implemented method of claim 4, wherein the weighting of the plurality constituents by updated optimum weights is repeated periodically.

6. The computer-implemented method of claim 5, wherein the financial instrument is indexed.

7. The computer-implemented method of claim 1, further comprising determining a covariance matrix from said characteristics, each element of said covariance matrix being a covariance between constituents of the financial instrument.

8. The computer-implemented method of claim 7, wherein the variance of the financial instrument is based at least in part on the covariance matrix.

9. The computer-implemented method of claim 8, further comprising:
determining, from said characteristics, continuous returns for each of the plurality of constituents; and
generating the covariance matrix based at least in part on said determined continuous returns.

10. The computer-implemented method of claim 9, wherein the variance of the financial instrument is defined by:
$${σ}_{fi}^{2} = {\sum }_{i = 1}^{n} {\sum }_{j = 1}^{n} {x}_{i} \cdot {x}_{j} \cdot {cov}_{i , j} = {\sum }_{i = 1}^{n} {\sum }_{j = 1}^{n} {x}_{i} \cdot {x}_{j} \cdot {σ}_{i} \cdot {σ}_{j} \cdot {r}_{i , j}$$
$$\text{where:}$$
$${σ}_{i} = \sqrt{HT \cdot \frac{1}{p - 1} {\sum }_{k = 1}^{p} {( {λ}_{ik} - \overline{{λ}_{i}} \text{)} )}^{2}} , \\ {λ}_{ik} = ln ( \frac{{Constituent}_{k}}{{Constituent}_{k - 1}} ) , \\ {cov}_{i , j} = HT \cdot \frac{1}{p - 1} {\sum }_{k = 1}^{p} ( {λ}_{ik} - \overline{{λ}_{i}} ) \cdot ( {λ}_{jk} - \overline{{λ}_{j}} ) , \\ {r}_{i , j} = \frac{{cov}_{i , j}}{{σ}_{i} \cdot {σ}_{j}} = \frac{\frac{1}{p - 1} {\sum }_{k = 1}^{p} ( {λ}_{ik} - \overline{{λ}_{i}} ) \cdot ( {λ}_{jk} - \overline{{λ}_{j}} )}{\sqrt{\frac{1}{p - 1} {\sum }_{k = 1}^{p} {( {λ}_{ik} - \overline{{λ}_{i}} )}^{2} \cdot \frac{1}{p - 1} {\sum }_{k = 1}^{p} {( {λ}_{jk} - \overline{{λ}_{j}} )}^{2}}} ,$$
where σ_{fi}² is the variance of the financial instrument, n is the total number of constituents comprised in the financial instrument, σᵢ is the variance of constituent i, xᵢ is the individual respective weight of the constituent i, cov_{i,j} is the element of the i-th column and the j-th row of the covariance matrix, λᵢₖ is the continuous return of constituent i at a particular point in time k, p is the total number of points in time for which λᵢₖ and λⱼₖ are determined, λ̅ᵢ̅ is an average of the continuous returns of constituent i. Constituentₖ is the value of constituent i at the point in time k and HT is the number of trading days.

11. The computer-implemented method of claim 10, wherein the variance of the financial instrument is minimized subject to the side conditions:
$$\begin{matrix}{\sum }_{1}^{n} {x}_{i} = 1 & ( 1 ) \\ {x}_{i} \geq 0 , where i = 1 , … , n . & ( 2 )\end{matrix}$$

12. The computer-implemented method of claim 9, wherein the continuous return is determined on a daily basis.

13. The computer-implemented method of claim 5, wherein the first period of time is 12 months and the second period of time is three months.

14. A computer-readable medium storing instructions that, when executed by a processor, cause said processor to generate a financial instrument having a plurality of constituents weighted by respective individual constituent weights by:
receiving data recorded over a first predetermined period of time, said data reflecting properties of each of the plurality of constituents;
determining optimum constituent weights for all of the plurality of constituents by maximizing a ratio based on a total return of said financial instrument and a variance of said financial instrument, both said total return and said variance being based on said properties; and
associating each respective individual constituent weight with its respective determined optimum constituent weight.

15. The computer-readable medium of claim 14, wherein the financial instrument is indexed.

16. The computer-readable medium of claim 14, further having stored instructions that, when executed by the processor, cause said processor to generate a financial instrument by:
maintaining said association of each respective individual constituent weight with its respective determined optimum constituent;
monitoring data reflecting properties of each of the plurality of constituents while maintaining said association; and
recording said monitored data.

17. The computer-readable medium of claim 16, further having stored instructions that, when executed by the processor, cause said processor to generate a financial instrument by:
determining, after a second period of time has elapsed, updated optimum constituent weights for all of the plurality of constituents by maximizing a further ratio based on a further total return of the financial instrument and a further variance of the financial instrument, both said further total return and said further variance being based on properties recorded during a third period of time; and
associating each respective individual constituent weight with its respective determined updated optimum constituent weight.

18. The computer-readable medium of claim 17, wherein the duration of the third period of time equals the duration of the first period of time and wherein the third period of time ends before the updated optimum constituent weights are determined.

19. The computer-readable medium of claim 18, wherein the step of associating each respective individual constituent weight with its respective determined updated optimum constituent weight is repeated periodically.

20. The computer-readable medium of claim 14 further having stored instructions that, when executed by the processor, cause said processor to generate a financial instrument by determining a covariance matrix from said properties, each element of said covariance matrix being a covariance between constituents of the financial instrument.

21. The computer-readable medium of claim 20, wherein the variance of the financial instrument is based at least in part on the covariance matrix.

22. The computer-readable medium of claim 21 further having stored instructions that, when executed by the processor, cause said processor to generate a financial instrument by:
determining, from said properties, continuous returns for each of the plurality of constituents; and
generating the covariance matrix based at least in part on said determined continuous returns.

23. The computer-readable medium of claim 22, wherein the variance of the financial instrument is defined by:
$${σ}_{fi}^{2} = {\sum }_{i = 1}^{n} {\sum }_{j = 1}^{n} {x}_{i} \cdot {x}_{j} \cdot {cov}_{i , j} = {\sum }_{i = 1}^{n} {\sum }_{j = 1}^{n} {x}_{i} \cdot {x}_{j} \cdot {σ}_{i} \cdot {σ}_{j} \cdot {r}_{i , j}$$
$$\text{where:}$$
$${σ}_{i} = \sqrt{HT \cdot \frac{1}{p - 1} {\sum }_{k = 1}^{p} {( {λ}_{ik} - \overline{{λ}_{i}} \text{)} )}^{2}} , \\ {λ}_{ik} = ln ( \frac{{Constituent}_{k}}{{Constituent}_{k - 1}} ) , \\ {cov}_{i , j} = HT \cdot \frac{1}{p - 1} {\sum }_{k = 1}^{p} ( {λ}_{ik} - \overline{{λ}_{i}} ) \cdot ( {λ}_{jk} - \overline{{λ}_{j}} ) , \\ {r}_{i , j} = \frac{{cov}_{i , j}}{{σ}_{i} \cdot {σ}_{j}} = \frac{\frac{1}{p - 1} {\sum }_{k = 1}^{p} ( {λ}_{ik} - \overline{{λ}_{i}} ) \cdot ( {λ}_{jk} - \overline{{λ}_{j}} )}{\sqrt{\frac{1}{p - 1} {\sum }_{k = 1}^{p} {( {λ}_{ik} - \overline{{λ}_{i}} )}^{2} \cdot \frac{1}{p - 1} {\sum }_{k = 1}^{p} {( {λ}_{jk} - \overline{{λ}_{j}} )}^{2}}} ,$$
where σ_{fi}² is the variance of the financial instrument, n is the total number of constituents comprised in the financial instrument, σᵢ is the variance of constituent i, xᵢ is the individual respective weight of the constituent i, cov_{i,j} is the element of the i-th column and the j-th row of the covariance matrix, λᵢₖ is the continuous return of constituent i at a particular point in time k, p is the total number of points in time for which λᵢₖ and λⱼₖ are determined, λ̅ᵢ̅ is an average of the continuous returns of constituent i. Constituentₖ is the value of constituent i at the point in time k and HT is the number of trading days.

24. The computer-readable medium of claim 23, wherein the ratio based on the return and the variance of the financial instrument is defined by:
$${sr}_{fi} = \frac{{r}_{fi} - {r}_{f}}{{σ}_{fi}}$$
$${r}_{fi} = {π}_{1} \cdot {x}_{1} + … + {π}_{n} \cdot {x}_{n}$$
where sr_{fi} is the ratio, r_{fi} is the total return of the financial instrument, r_{f} is a floor return level, σ_{fi} is the square-root of variance of the financial instrument, π₁, . . . , πₙ are the returns and x₁, . . . , xₙ the respective weights of the n constituents comprised in the financial instrument.

25. The computer-readable medium of claim 22, wherein the continuous return is determined on a daily basis and the total return is determined on a annual basis.

26. The computer-readable medium of claim 19, wherein the first period of time is 12 months and the second period of time is three months.

27. A data processing apparatus for adjusting constituent weights of a financial instrument having a plurality of constituents, the apparatus comprising:
a data input unit configured to receive information associated with said plurality of constituents; and
an adjuster configured to:
determine a continuous return for each of said plurality of constituents based on said received information;
generate a covariance matrix based at least in part on said determined continuous returns; and
adjust said constituent weights using said covariance matrix.

28. The data processing apparatus of claim 26, wherein said constituent weights are adjusted periodically.

29. The data processing apparatus of claim 28 further comprising an indexer configured to associate the financial instrument with an index reflecting a composite value of the plurality of constituents.

30. The data processing apparatus of claim 29, wherein the adjuster is further configured to determine a variance of the financial instrument based on the covariance matrix.

31. The data processing apparatus of claim 30, wherein the adjuster is further configured to:
calculate optimum constituent weights for all of the plurality of constituents by minimizing the financial instrument variance; and
adjust said constituent weights by replacing said constituent weights with said calculated optimum constituent weights.

32. The data processing apparatus of claim 29, wherein the adjuster is further configured to:
calculate optimum constituent weights for all of the plurality of constituents by maximizing a ratio based on a total return of the financial instrument and the variance of said financial instrument; and
adjust said constituent weights by replacing said constituent weights with said calculated optimum constituent weights.
